(19) United States
(12) Patent Application Publication
(10) Pub. No.: US 2014/0283606 A1
(43) Pub. Date: Sep. 25, 2014

(54) ACCELERATION SENSOR

(71) Applicant: Murata Manufacturing Co., Ltd., Nagaokakyo-shi (JP)

(72) Inventor: Hiroshi HAMAMURA, Nagaokakyo-shi (JP)

(21) Appl. No.: 14/301,360

(22) Filed: Jun. 11, 2014

Related U.S. Application Data
(63) Continuation of application No. PCT/JP2012/082005, filed on Dec. 11, 2012.

(30) Foreign Application Priority Data
Dec. 12, 2011 (JP) 2011-271321

(51) Int. Cl. G01P 15/12

(52) U.S. Cl. CPC G01P 15/123
USPC 73/514.33

(57) ABSTRACT

An acceleration sensor includes a weight, a supporting portion arranged so as to face the weight, beams configured to be flexible and connect the weight and the supporting portion, and piezoresistive elements disposed at the beams, wherein the weight oscillates in a pendulum motion while using center portions of the beams as fulcrums.

### BACKGROUND OF THE INVENTION

1. Field of the Invention

The present invention relates to acceleration sensors that include piezoresistive elements.

2. Description of the Related Art

Japanese Unexamined Patent Application Publication No. 2009-128269 discloses an acceleration sensor for detecting acceleration in one axis direction. Here, the one axis direction is a thickness direction of an acceleration sensor element that constitutes the acceleration sensor. The acceleration sensor described in Japanese Unexamined Patent Application Publication No. 2009-128269 includes a weight supported by a supporting frame via a beam that serves as a deflecting portion. In other words, the beam is connected to the supporting frame at one end portion and the weight at the other end portion. In Japanese Unexamined Patent Application Publication No. 2009-128269, the acceleration sensor is disclosed as a micro-electro-mechanical systems (MEMS) piezoresistive acceleration sensor.

This acceleration sensor may be, for example, installed in a hard disk drive (HDD). Further, the HDD is configured so that a protection feature is initiated when there is an impact on the HDD in order to stop data reading and writing, thereby protecting the HDD against impact-induced failure. To implement such a protection feature, the acceleration sensor is installed for detecting acceleration of the HDD.

In HDD protection features, there are cases where the detection of acceleration is necessary not only in a first axis direction (direction of plane of HDD and acceleration sensor: hereinafter, referred to as Y axis direction) but also in a second axis direction (thickness direction of HDD and acceleration sensor: hereinafter, referred to as Z axis direction). In such cases, it is possible to install an acceleration sensor for detecting the Y axis direction acceleration and another acceleration sensor for detecting the Z axis direction acceleration in a HDD. However, this poses a problem of an increase in the number of components. In view of this, it is conceivable that a HDD may be provided with an acceleration sensor whose direction of detection is inclined at a predetermined angle with respect to the Z axis direction.

However, it is difficult for the acceleration sensor described in Japanese Unexamined Patent Application Publication No. 2009-128269 to achieve bandwidth and sensitivity required for detecting impact when trying to detect acceleration in the direction inclined at a predetermined angle with respect to the Z axis direction.

### SUMMARY OF THE INVENTION

Preferred Embodiments of the present invention provide an acceleration sensor that has an inclined direction of detection with respect to one axis and achieves wider bandwidth and higher sensitivity.

Further, other Preferred Embodiments of the present invention provide an acceleration sensor that achieves higher sensitivity with a smaller area size even when directions of detection are directions set along plural axes.

An acceleration sensor according to a Preferred Embodiment of the present invention includes a weight, a supporting portion arranged so as to face the weight, a beam configured to be flexible and connect the weight and the supporting portion, and a piezoresistive element disposed at the beam. This feature concentrates stress in the beam when the acceleration causes the beam to displace, making it possible to achieve a highly sensitive acceleration sensor.

This feature also makes it possible to have the direction of detection be a direction perpendicular or substantially perpendicular to a line segment connecting a fulcrum and a center of gravity of the weight.

Preferably, in the acceleration sensor according to a Preferred Embodiment of the present invention, one of the weight and the supporting portion preferably includes a protruded portion that protrudes toward the other one of the weight and the supporting portion, and the other one of the weight and the supporting portion preferably includes a recessed portion that faces the protruded portion. Further, the beam preferably includes a first beam disposed between the protruded portion and the recessed portion and a second beam disposed at a location that does not exist between the protruded portion and the recessed portion.

In this feature, stress is concentrated in the beam by providing opposing portions of the supporting portion and the weight in recess and protrusion shapes and connecting the supporting portion and the weight via the first beam and the second beam, thus making it possible to achieve a highly sensitive acceleration sensor.

Preferably, the acceleration sensor according to a Preferred Embodiment of the present invention preferably further includes a first piezoresistive bridge disposed at the first beam and a second piezoresistive bridge disposed at the second beam.

In this feature, a direction of acceleration detection by the first piezoresistive bridge does not align with a direction of acceleration detection by the second piezoresistive bridge. This makes it possible to separately detect acceleration in two axis directions based on outputs of the first piezoresistive bridge and the second piezoresistive bridge.

The acceleration sensor according to a Preferred Embodiment of the present invention is preferably configured so that the protruded portion is located inside the recessed portion.

The acceleration sensor according to a Preferred Embodiment of the present invention is preferably configured so that the protruded portion is located outside the recessed portion.

Various Preferred Embodiments of the present invention makes it possible to concentrate stress in the beam and achieve a highly sensitive acceleration sensor even when the direction of detection is an inclined direction with respect to one axis. Further, various Preferred Embodiments of the present invention provide a highly sensitive acceleration sensor having a small area size even when the directions of detection are plural axis directions.

The above and other elements, features, steps, characteristics and advantages of the present invention will become more apparent from the following detailed description of the Preferred Embodiments with reference to the attached drawings.

### BRIEF DESCRIPTION OF THE DRAWINGS

FIGS. 1A and 1B are a schematic plan view and a schematic side view of an acceleration sensor according to Preferred Embodiment 1 of the present invention, where FIG. 1A is a top plan view, and FIG. 1B is a side cross-sectional view at line I-I of FIG. 1A.

FIG. 2 is a schematic side view illustrating a mode of pendulum oscillation at the acceleration sensor according to Preferred Embodiment 1 of the present invention.

FIGS. 3A-3D are cross-sectional views illustrating a fabrication method of the acceleration sensor according to Preferred Embodiment 1 of the present invention.

FIG. 4 is a schematic perspective view of an acceleration sensor according to Preferred Embodiment 2 of the present invention.

FIGS. 5A-5C are a schematic plan view and schematic side cross-sectional views of the acceleration sensor according to Preferred Embodiment 2 of the present invention, where FIG. 5A is a top plan view, FIG. 5B is a side cross-sectional view at line VA-VA of FIG. 5A, and FIG. 5C is a side cross-sectional view at line VB-VB of FIG. 5A.

FIGS. 6A and 6B are a circuit diagram and a schematic plan view illustrating an arrangement of piezoresistive elements and a fulcrum at time of pendulum oscillation in the acceleration sensor according to Preferred Embodiment 2 of the present invention, where FIG. 6A is a top plan view, and FIG. 6B is a circuit diagram.

FIGS. 7A-7C are a schematic plan view and schematic side views of an acceleration sensor according to Preferred Embodiment 3 of the present invention, where FIG. 7A is a top plan view, FIG. 7B is a side cross-sectional view at line VA-VA of FIG. 7A, and FIG. 7C is a side cross-sectional view at line VB-VB of FIG. 7A.

FIGS. 8A-8C are diagrams illustrating an acceleration derivation method and exemplary outputs of the acceleration sensor according to Preferred Embodiment 3 of the present invention. FIG. 8A is a chart illustrating outputs of a first piezoresistive bridge, FIG. 8B is a chart illustrating outputs of a second piezoresistive bridge, and FIG. 8C is a graph illustrating a relationship between direction of input acceleration and ratio of outputs of the piezoresistive bridges.

FIGS. 9A-9C are a schematic perspective view and schematic plan views of an acceleration sensor according to Preferred Embodiment 4 of the present invention, where FIG. 9A is a schematic perspective view, FIG. 9B is a top plan view, and FIG. 9C is a bottom plan view.

FIG. 10 is a schematic perspective view of a first modification example of the acceleration sensor according to Preferred Embodiment 2 of the present invention.

FIGS. 11A-11D are schematic plan views of second to fifth modification examples of the acceleration sensor according to Preferred Embodiment 2 of the present invention.

FIGS. 12A-12D are schematic plan views of sixth to ninth modification examples of the acceleration sensor according to Preferred Embodiment 2 of the present invention.

### DETAILED DESCRIPTION OF THE PREFERRED EMBODIMENTS

### Preferred Embodiment 1

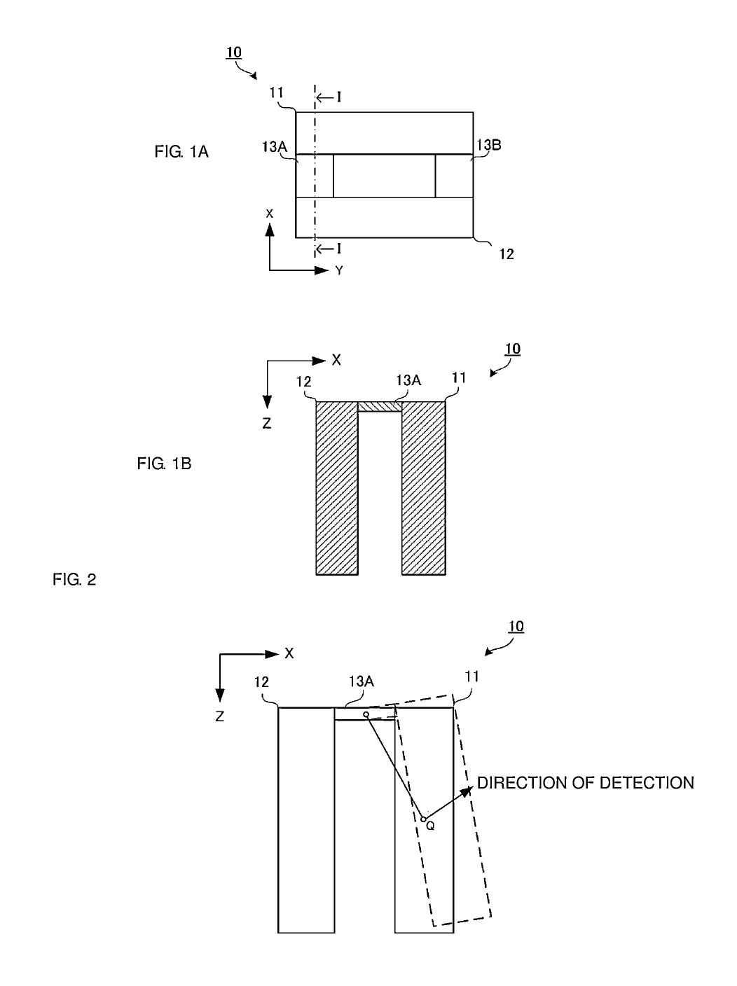

An acceleration sensor 10 according to Preferred Embodiment 1 of the present invention is described with reference to the drawings. FIGS. 1A and 1B are a schematic plan view and a schematic side cross-sectional view of the acceleration sensor 10 according to Preferred Embodiment 1 of the present invention. FIG. 1A is a top plan view of the acceleration sensor 10. FIG. 1B is a side cross-sectional view at line I-I of FIG. 1A. In FIG. 1A and FIG. 1B, X axis, Y axis, and Z axis of a perpendicular coordinate system are additionally illustrated.

The acceleration sensor 10 is a micro-electro-micro-electromechanical systems (MEMS) piezoresistive acceleration sensor. As illustrated in FIG. 1A and FIG. 1B, the acceleration sensor 10 includes a weight 11, a supporting portion 12, and beams 13A and 13B. The weight 11 is preferably formed by performing micro-fabrication such as etching processing and the like, which will be described later, on a silicon-on-insulator (SOI) substrate, for example. In the present Preferred Embodiment, the weight 11 preferably has a rectangular or substantially rectangular shape in an X-Y axis plane. Further, the weight 11 has a predetermined length in the Z axis direction.

The weight 11 and the supporting portion 12 face each other in the X axis direction. The weight 11 is connected to the supporting portion 12 via the beams 13A and 13B. Further, the supporting portion 12 has a predetermined length in the Z axis direction.

The beams 13A and 13B are each flexible and have a plate shape, and connect the weight 11 and the supporting portion 12. In other words, the acceleration sensor 10 has a cantilever structure in which the weight 11 is supported by the beams 13A and 13B. The beams 13A and 13B connect the weight 11 and the supporting portion 12.

The beams 13A and 13B are provided with piezoresistive elements 14A and 14B. The piezoresistive elements 14A and 14B detect stresses in the beams 13A and 13B. Specifically, when the acceleration sensor 10 is accelerated, acceleration causes the beams 13A and 13B to bend, and stress arises in the beams 13A and 13B. The bending of the beams 13A and 13B creates stresses in the piezoresistive elements 14A and 14B, and changes resistances of the piezoresistive elements 14A and 14B. In this way, changes in resistances of the piezoresistive elements 14A and 14B enable detection of the magnitudes of stresses in the beams 13A and 13B, and detection results of the piezoresistive elements 14A and 14B enable measurement of the acceleration of the acceleration sensor 10.

FIG. 2 is a schematic side view of the acceleration sensor 10 according to Preferred Embodiment 1 of the present invention during presence of acceleration.

In the acceleration sensor 10, an angle defined with respect to a line connecting a fulcrum and a center of gravity Q of the weight 11 serves as an inclination angle with respect to one axis (Z axis). Further, in the acceleration sensor 10, a direction of detection is a direction (direction including components in the X axis direction and the Z axis direction) perpendicular or substantially perpendicular to a direction inclined at the inclination angle with respect to the one axis (Z axis). Thus, the inclination angle with respect to the one direction (Z axis) may be set to any desired angle by adjusting the angle defined with respect to the line connecting the fulcrum and the center of gravity Q of the weight 11. Accordingly, the direction of detection may be set to any desired direction.

Further, in the acceleration sensor 10, the line connecting the fulcrum and the center of gravity Q of the weight 11, which is illustrated in FIG. 2, defines the inclination angle with respect to the one axis (Z axis). Accordingly, the acceleration sensor 10 is capable of detecting accelerations in the Z axis direction and the X axis direction. This makes it possible to achieve a highly sensitive uniaxial acceleration sensor in which the direction of detection is an inclined direction with respect to one axis.

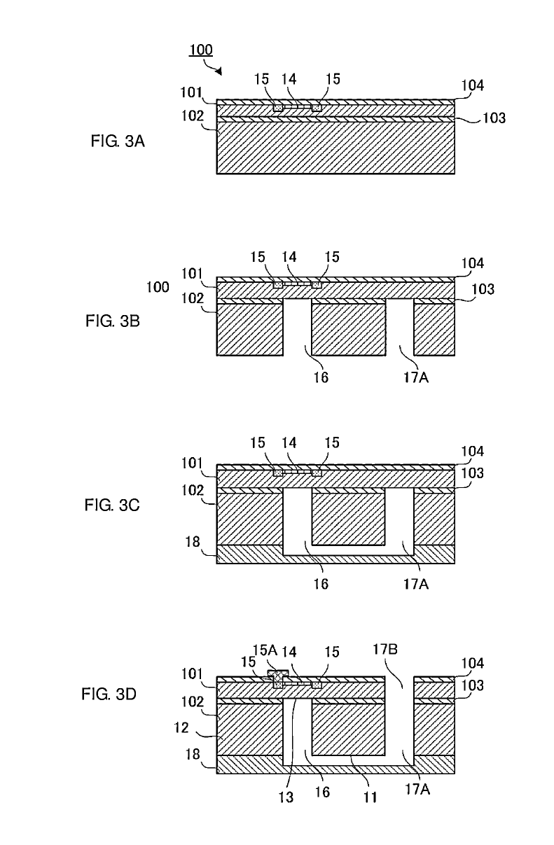

Next, an example of a fabrication method of the acceleration sensor 10 according to Preferred Embodiment 1 of the present invention is described. FIGS. 3A-3D are cross-sectional views illustrating the fabrication method of the acceleration sensor 10 according to Preferred Embodiment 1 of the present invention. A device including the acceleration sensor 10 illustrated in FIGS. 1A and 1B is fabricated by the fabrication method illustrated in FIGS. 3A-3D. Further, the cross-sectional views illustrated in FIGS. 3A-3D correspond to the side cross-sectional view illustrated in the foregoing FIG. 1B. Note that, in the following description, the beams 13A and 13B are collectively referred to as a beam 13, and the piezoresistive elements 14A and 14B are collectively referred to as a piezoresistive element 14.

First, as illustrated in FIG. 3A, a SOI substrate 100 is prepared. The SOI substrate 100 preferably includes a silicon substrate 101, a silicon substrate 102, and an insulator layer 103 interposed between these substrates and made of, for example, SiO₂ or SiN. Further, in the present Preferred Embodiment, an insulator layer 104 is provided on a surface of the silicon substrate 101. Here, it is desirable that a total thickness of the silicon substrate 101 and the insulator layers 103 and 104 becomes equal or substantially equal to a thickness of the beam 13.

The piezoresistive element 14 (P+ layer) is formed on a surface side of the silicon substrate 101 of the SOI substrate 100 at a location that later becomes a center portion of the beam 13 by use of photolithography technique and doping technique. Further, low resistance wiring regions (P++ layer) that become wiring electrode patterns 15 are formed at an equal or substantially equal depth position of the silicon substrate 101 so as to form predetermined patterns.

Next, as illustrated in FIG. 3B, with the use of a photolithography technique and etching technique, dry etching is performed from a back side (side where the silicon substrate 102 is disposed) of the SOI substrate 100 with a fluorine gas (CF₄, C₄F₈, SF₆, or the like) or a chlorine gas (Cl₂) to form a space 16 that later becomes a space between the weight 11 and the supporting portion 12 and a space 17A that later becomes a space to allow the weight 11 to have a pendulum oscillation motion. Subsequently, as illustrated in FIG. 3C, a cover member 18 is bonded with the SOI substrate 100 from the back side (side where the silicon substrate 102 is disposed). Further, it is desirable that the cover member 18 is made of the same material as that of the silicon substrate 102.

Next, as illustrated in FIG. 3D, by using a photolithography technique and etching technique, dry etching is performed from the surface side (side where the insulator layer 104 is disposed) of the SOI substrate 100 to form a space 17B that communicates with the space 17A. Further, a wiring electrode pattern 15A is formed on a surface of the insulator layer 104, namely, the surface of the SOI substrate 100. Although it is not illustrated in the figure, this wiring electrode pattern 15A is formed so as to be connected to the low resistance wiring region of the silicon substrate 101. Subsequently, dry etching is performed to remove portions of the insulator layer 104, the silicon substrate 101, and the insulator layer 103 from the surface side of the SOI substrate 100 so as to leave corresponding portions that later become the weight 11, the supporting portion 12, and the beams 13A and 13B. According to the foregoing steps, a structure is actualized in which the weight 11 is supported via the beam 13.

### Preferred Embodiment 2

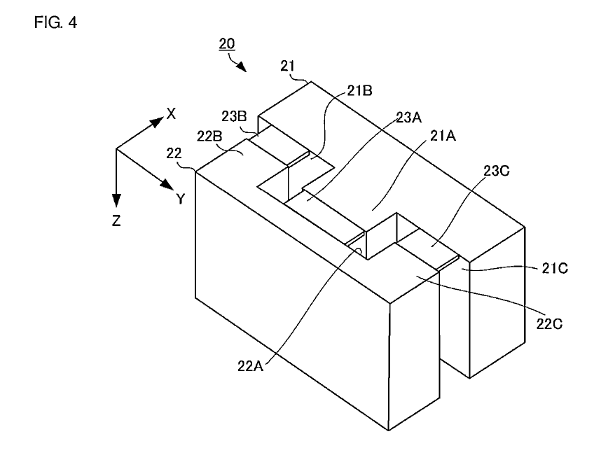

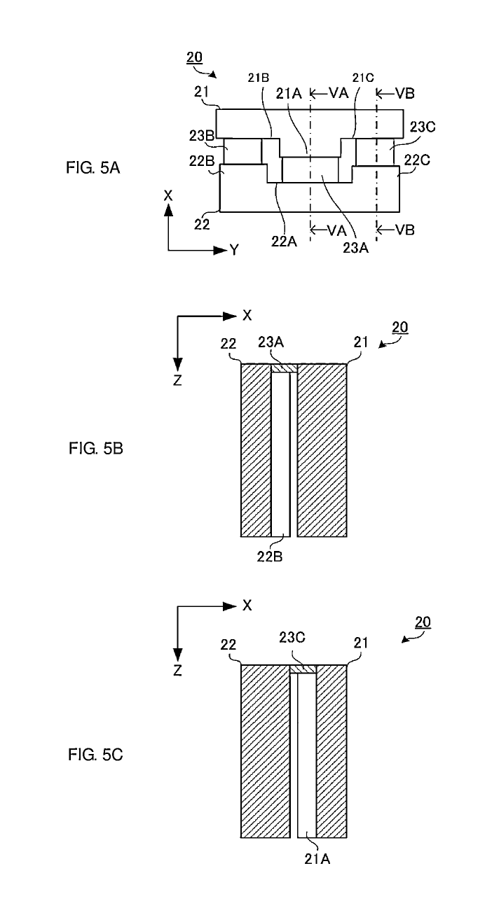

Next, an acceleration sensor 20 according to Preferred Embodiment 2 of the present invention is described. FIG. 4 is a schematic perspective view of the acceleration sensor 20 according to Preferred Embodiment 2 of the present invention. FIGS. 5A-5C are a schematic plan view and schematic side cross-sectional views of the acceleration sensor 20 according to Preferred Embodiment 2 of the present invention. FIG. 5A is a top plan view of the acceleration sensor 20. FIG. 5B is a side cross-sectional view at line VA-VA of FIG. 5A. FIG. 5C is a side cross-sectional view at line VB-VB of FIG. 5A. As with FIG. 1, X axis, Y axis, and Z axis of a perpendicular coordinate system are additionally illustrated in FIG. 4 and FIGS. 5A to 5C.

The acceleration sensor 20 according to Preferred Embodiment 2 includes a weight 21, a supporting portion 22, and beams 23A, 23B and 23C. As with Preferred Embodiment 1, the weight 21 is preferably formed by performing micro-fabrication such as pattern etching processing and the like on a SOI substrate. In the present Preferred Embodiment, the weight 21 has, in the X-Y axis plane, a protrusion shape including a rectangular or substantially rectangular portion whose longer side is aligned with the Y axis direction and a protruded portion 21A disposed at or substantially at a center of the longer side of the rectangular or substantially rectangular portion. The protruded portion 21A protrudes toward the supporting portion 22. Further, the weight 21 has a predetermined length in the Z axis direction. In the following description, two regions of the weight 21 that sandwich the protruded portion 21A in the Y axis direction are referred to as regions 21B and 21C. Note that, as to the weight 21, the lengths in the X, Y, and Z axis directions and the size or location or the like of the protruded portion 21A may be set arbitrarily.

The weight 21 and the supporting portion 22 face each other in the X axis direction. The weight 21 is connected to the supporting portion 22 via the beams 23A, 23B, and 23C. The supporting portion 22 has, in the X-Y axis plane, a recess shape including a rectangular or substantially rectangular portion whose longer side has the same or substantially the same length as that of the weight 21 and is aligned with the Y axis direction. This recess shape further includes two protruded portions at both end portions of the longer side of the rectangular or substantially rectangular portion. The supporting portion 22 defines, in the X-Y axis plane, the recess shape including a recessed portion 22A at a portion that faces the protruded portion 21A of the weight 21. In the following description, portions of the supporting portion 22 that surround the recessed portion 22A are referred to as surrounding portions 22B and 22C. The supporting portion 22 is arranged so that the surrounding portions 22B and 22C face the regions 21B and 21C of the weight 21, respectively.

The beams 23A, 23B, and 23C each have a flexible plate shape, and connect the weight 21 and the supporting portion 22. In other words, the acceleration sensor 20 has a cantilever structure in which the weight 21 is supported with the beams 23A, 23B, and 23C. The beam 23A connects the protruded portion 21A of the weight 21 and the recessed portion 22A of the supporting portion 22. The beam 23B connects the region 21B of the weight 21 and the surrounding portion 22B of the supporting portion 22. The beam 23C connects the region 21C of the weight 21 and the surrounding portion 22C of the supporting portion 22.

Although the weight 21 is preferably configured such that the protruded portion 21A is provided only on the side that faces the supporting portion 22, the weight 21 may alternatively be configured to have a shape in which a protruded portion is provided on the opposite side to the supporting portion 22.

In the acceleration sensor 20 according to Preferred Embodiment 2, the weight 21 and the supporting portion 22 have planar shapes with protrusion and recess shapes. Further, a location at which the weight 21 is supported by the beam 23A does not align with locations at which the weight 21 is supported by the beams 23B and 23C. Further, the weight 21 and the supporting portion 22 are arranged so that the protruded portion 21A of the weight 21 does not enter inside the recessed portion 22A of the supporting portion 22. Accordingly, stress is concentrated between lines L1 and L2.

Further, as with Preferred Embodiment 1, the direction of detection of the acceleration sensor 20 of Preferred Embodiment 2 is an inclined direction (direction including components in the X axis direction and the Z axis direction) with respect to one axis. Note that, the inclination angle with respect to the one axis may be set to any desired angle by adjusting a ratio of widths (lengths in the Y axis direction) of the beams 23A, 23B, and 23C, center locations of the widths of the beams 23A, 23B, and 23C, and a location of the center of gravity of the weight 21.

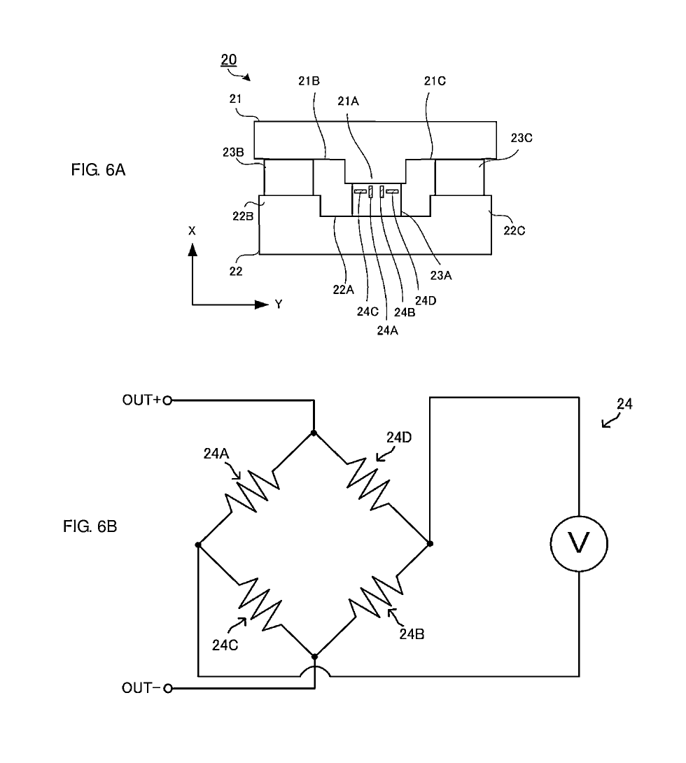

As illustrated in FIG. 6A, piezoresistive elements 24A, 24B, 24C, and 24D to detect stress are disposed at a portion between the lines L1 and L2, where a maximum stress occurs.

When the acceleration sensor 20 is accelerated, the acceleration causes the weight 21 to displace and the beams 23A, 23B, and 23C to bend, and stress arises in the beams 23A, 23B, and 23C. The bending of the beams 23A, 23B, and 23C creates stresses in the piezoresistive elements 24A to 24D, and this changes resistance values of the piezoresistive elements 24A to 24D. The changes in resistances of the piezoresistive elements 24A to 24D enable detection of the magnitudes of stresses in the beams 23A, 23B, and 23C, and detection results of the piezoresistive elements 24A to 24D enable measurement of the acceleration of the acceleration sensor 20.

FIG. 6B is a circuit diagram illustrating a configuration example of a piezoresistive bridge that uses the piezoresistive elements 24A to 24D.

The piezoresistive elements 24A to 24D are connected so as to define a Wheatstone bridge, and define a piezoresistive bridge 24. Specifically, the piezoresistive element 24A and the piezoresistive element 24C are connected in series. Further, the piezoresistive element 24D and the piezoresistive element 24B are also connected in series. A series circuit including the piezoresistive elements 24A and 24C and a series circuit including the piezoresistive elements 24D and 24B are connected at the piezoresistive element 24A and the piezoresistive element 24D. Further, these two series circuits are connected at the piezoresistive element 24C and the piezoresistive element 24B. Further, a constant voltage source Vdd is connected between a connection point of the piezoresistive element 24A and the piezoresistive element 24D and a connection point of the piezoresistive element 24C and the piezoresistive element 24B. Still further, a voltage measurement circuit is connected between a connection point of the piezoresistive element 24A and the piezoresistive element 24C and a connection point of the piezoresistive element 24D and the piezoresistive element 24B. Note that a constant current source may alternatively be used in place of the constant voltage source Vdd.

### Preferred Embodiment 3

Next, an acceleration sensor 30 according to Preferred Embodiment 3 of the present invention is described. As with Preferred Embodiments 1 and 2, the acceleration sensor 30 according to Preferred Embodiment 3 has a shorter substantive beam length during oscillation compared with the actual beam length, making it possible to achieve a highly sensitive acceleration sensor.

Note that the acceleration sensor 30 according to Preferred Embodiment 3 is configured to detect accelerations in two axes, not to detect acceleration in one inclined axis.

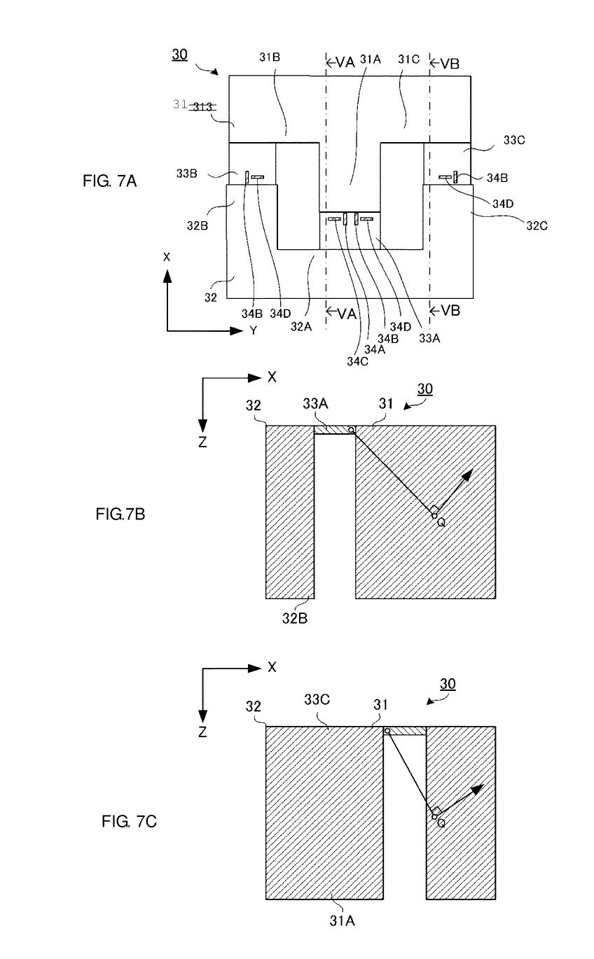

FIGS. 7A-7C are a schematic plan view and schematic side cross-sectional views of the acceleration sensor 30 according to Preferred Embodiment 3 of the present invention. FIG. 7A is a top plan view of the acceleration sensor 30. FIG. 7B is a side cross-sectional view at line VA-VA of FIG. 7A. FIG. 7C is a side cross-sectional view at line VB-VB of FIG. 7A. In FIGS. 7A to 7C, X axis, Y axis, and Z axis of a perpendicular coordinate system are additionally illustrated.

The acceleration sensor 30 includes a weight 31, a supporting portion 32, and beams 33A, 33B and 33C. As with Preferred Embodiment 2, the weight 31 has, in the X-Y axis plane, a protrusion shape including a rectangular or substantially rectangular portion whose longer side is aligned with the Y axis direction and a protruded portion 31A disposed substantially at a center of the longer side of the rectangular or substantially rectangular portion. The protruded portion 31A protrudes toward the supporting portion 32. Further, the weight 31 has a predetermined length in the Z axis direction. In the following description, two regions of the weight 31 that sandwich the protruded portion 31A in the Y axis direction are referred to as regions 31B and 31C. Note that, as to the weight 31, the lengths in the X, Y, and Z axis directions and the size or location or the like of the protruded portion 31A may be set arbitrarily.

The weight 31 and the supporting portion 32 face each other in the X axis direction. The weight 31 is connected to the supporting portion 32 via the beams 33A, 33B, and 33C. The supporting portion 32 has, in the X-Y axis plane, a recess shape including a rectangular or substantially rectangular portion whose longer side has the same or substantially the same length as that of the weight 31 and is aligned with the Y axis direction. The recess shape further includes two protruded portions disposed at both end portions of the longer side of the rectangular portion. The supporting portion 32 has, in the X-Y axis plane, the recess shape including a recessed portion 32A at a portion that faces the protruded portion 31A of the weight 31. In the following description, portions of the supporting portion 32 that surround the recessed portion 32A are referred to as surrounding portions 32B and 32C. The supporting portion 32 is arranged so that these surrounding portions 32B and 32C face the regions 31B and 31C of the weight 31, respectively.

A first resonance mode of the acceleration sensor 30 is an oscillation mode in which the weight 31 oscillates in pendulum motion. FIG. 7A illustrates a line L1 that is parallel to the Y axis direction and passes through a center of the beam 33A and a line L2 that is parallel to the Y axis direction and passes through centers of the beams 33B and 33C.

As illustrated in FIG. 7A, in the acceleration sensor 30 according to Preferred Embodiment 3, the weight 31 and the supporting portion 32 have planar shapes with protrusion and recess shapes. Further, the location at which the weight 31 is supported by the beam 33A does not align with the locations at which the weight 31 is supported by the beams 33B and 33C. Further, the weight 31 and the supporting portion 32 are arranged so that the protruded portion 31A of the weight 31 enters inside the recessed portion 32A of the supporting portion 32. These enable the weight 31 to have a pendulum motion about a portion between the lines L1 and L2 illustrated in FIG. 7A. Here, the portion between the lines L1 and L2 serves as a fulcrum. During the pendulum oscillation of the weight 31, the beams 33A, 33B, and 33C each deform in a wave-like manner where the beams 33A, 33B, and 33C each bend at both end portions. Thus, stresses are concentrated in the beams 33A, 33B, and 33C.

In the acceleration sensor 30 according to Preferred Embodiment 3, the direction of acceleration to be detected at the beam 33A illustrated in FIG. 7B does not align with the direction of acceleration to be detected at the beams 33B and 33C illustrated in FIG. 7C. This makes it possible to provide two directions of detection, which differ in inclination angle with respect to the one axis (Z axis). Further, arithmetic processing makes it possible to separate acceleration in the X axis direction and acceleration in the Z axis direction from outputs of the piezoresistive elements.

Note that, in this configuration, the direction of detection may be set to any inclination angle from the X axis direction to the Z axis direction by changing angle setting between the beams 33A, 33B, and 33C, and the center of gravity position of the weight 31. Further, a larger number of directions of detection may be achieved by having a larger number of beams that are sifted in the X axis direction. Further, the weight 31 is supported with a cantilever structure. Thus, there is less possibility to be affected by an external stress, and an area size of acceleration sensor may be made smaller even when the acceleration sensor is configured to detect accelerations in two axis directions.

Here, as illustrated in FIG. 7A, piezoresistive elements 34A, 34B, 34C, and 34D that achieve a first detection direction are disposed at a portion of the beam 33A, where a maximum stress occurs when the weight 31 is displaced. Further, piezoresistive elements 35A, 35B, 35C, and 35D that achieve a second detection direction are disposed at portions of the beams 33B and 33C, where maximum stresses occur. The piezoresistive elements 34A, 34B, 34C, and 34D define a first piezoresistive bridge that has a circuit configuration similar to that of Preferred Embodiment 2. Further, the piezoresistive elements 35A, 35B, 35C, and 35D define a second piezoresistive bridge that has a circuit configuration similar to that of Preferred Embodiment 2.

Here, specific exemplary outputs of the first piezoresistive bridge and the second piezoresistive bridge and a derivation method of input acceleration based on these exemplary outputs are described.

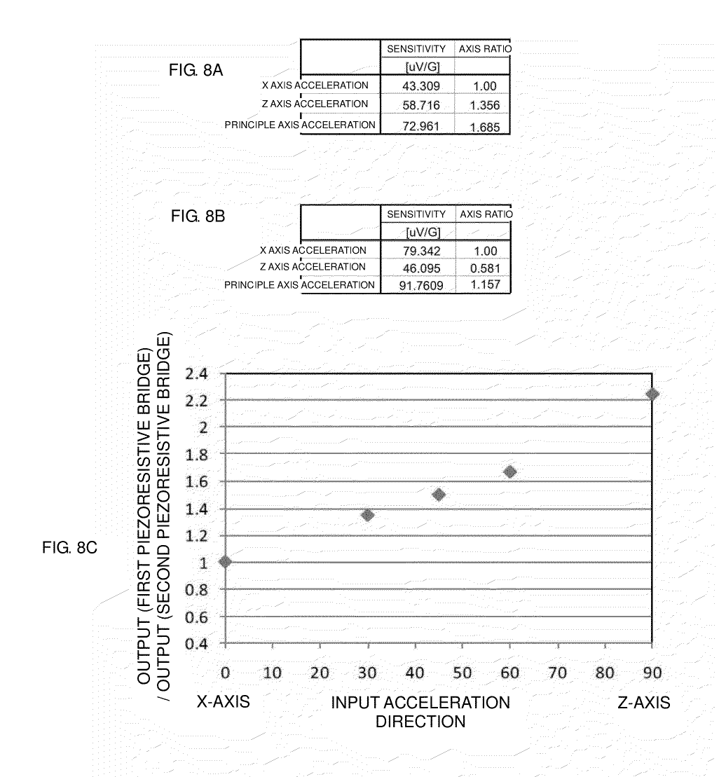

FIG. 8A is a diagram for describing sensitivity of the first piezoresistive bridge disposed at the beam 33A. FIG. 8B is a diagram for describing sensitivity of the second piezoresistive bridge disposed at the beams 33B and 33C.

As illustrated in FIG. 8A, the first piezoresistive bridge disposed at the beam 33A preferably has a sensitivity (X axis sensitivity) of about 43.309 μV/G to acceleration (X axis acceleration) in the X axis direction and a sensitivity (Z axis sensitivity) of about 58.716 μV/G to acceleration (Z axis acceleration) in the Z axis direction, for example. Further, the sensitivity (principle axis sensitivity) to acceleration in the direction of detection (principle axis direction) preferably is about 72.961 μV/G, for example. Note that an axis ratio of the Z axis sensitivity to the X axis sensitivity preferably is about 1.356 times, and an axis ratio of the principle axis sensitivity to the X axis sensitivity is about 1.685, for example.

As illustrated in FIG. 8B, the second piezoresistive bridge disposed at the beams 33B and 33C preferably has a sensitivity (X axis sensitivity) of about 79.342 μV/G to acceleration (X axis acceleration) in the X axis direction and a sensitivity (Z axis sensitivity) of about 46.095 μV/G to acceleration (Z axis acceleration) in the Z axis direction. Further, the sensitivity (principle axis sensitivity) to acceleration in the direction of detection (principle axis direction) preferably is about 91.760 μV/G. In other words, the axis ratio of the Z axis sensitivity to the X axis sensitivity preferably is about 0.581 times, and the axis ratio of the principle axis sensitivity to the X axis sensitivity preferably is about 1.157.

FIG. 8C is a graph illustrating a relationship between the direction of input acceleration and the ratio (output ratio) of the first piezoresistive bridge output to the second piezoresistive bridge output. The direction of input acceleration is 0 degrees in the X axis direction and 90 degrees in the Z axis direction. There is a relation between the direction of input acceleration and the output ratio. The output ratio may be calculated from the second piezoresistive bridge output and the first piezoresistive bridge output. Thus, the input acceleration direction may be derived based on the output ratio thus calculated.

Accordingly, the direction of input acceleration, the X axis acceleration, and the Y axis acceleration may be derived based on the output sensitivity of the first piezoresistive bridge and the output sensitivity of the second piezoresistive bridge.

### Preferred Embodiment 4

Next, an acceleration sensor 40 according to Preferred Embodiment 4 of the present invention is described. As with Preferred Embodiments 1, 2 and 3, the acceleration sensor 40 according to Preferred Embodiment 4 concentrates stress in presence of acceleration, making it possible to achieve a highly sensitive acceleration sensor.

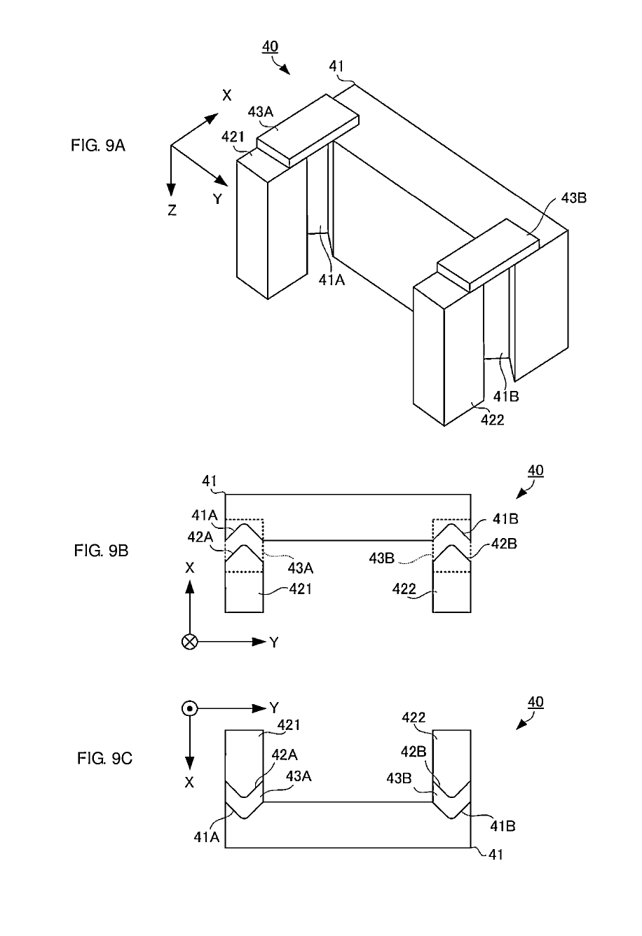

FIGS. 9A-9C are a schematic perspective view and schematic plan views of the acceleration sensor 40 according to Preferred Embodiment 4 of the present invention. FIG. 9A is a schematic perspective view of the acceleration sensor 40. FIG. 9B is a top plan view of the acceleration sensor 40. FIG. 9C is a bottom plan view of the acceleration sensor 40. Note that, for convenience of description, FIG. 9B illustrates a partially (beams 43A and 43B) transparent view.

The acceleration sensor 40 according to Preferred Embodiment 4 includes a weight 41, supporting portions 421 and 422, and beams 43A and 43B. As with Preferred Embodiment 1, 2, and 3, the weight 41 preferably is formed by performing micro-fabrication such as pattern etching processing and the like on a SOI substrate. In the present Preferred Embodiment, the weight 41 preferably has, in the X-Y axis plane, a rectangular or substantially rectangular shape whose longer side is aligned with the Y axis direction, and is provided with recessed portions 41A and 41B that include V-shape depressions. The recessed portions 41A and 41B are disposed at two end portions of the rectangular or substantially rectangular shape in the Y axis direction on a side facing the supporting portions 421 and 422. Further, the weight 41 has a predetermined length in the Z axis direction.

The weight 41 and the supporting portions 421 and 422 face each other in the X axis direction. The weight 41 is connected to the supporting portion 421 via the beam 43A and to the supporting portion 422 via the beam 43B. The supporting portions 421 and 422 have columnar shapes, each having the same or substantially the same length as that of the weight 41 in the Z axis direction and including a protruded portion that has a V-shape protrusion protruding toward the weight 41 in the X-Y axis plane. In the following section, the portions of the supporting portions 421 and 422 protruding outward are referred to as protruded portions 42A and 42B. The supporting portions 421 and 422 are arranged so that the protruded portions 42A and 42B face the recessed portions 41A and 41B, respectively.

The beams 43A and 43B have flexible plate shapes and connect the weight 41 and the supporting portions 421 and 422. The beam 43A is disposed on top surfaces of the recessed portion 41A of the weight 41 and the protruded portion 42A of the supporting portion 421, and connects the weight 41 and the supporting portion 421. The beam 43B is disposed on top surfaces of the recessed portion 41B of the weight 41 and the protruded portion 42B of the supporting portion 422, and connects the weight 41 and the supporting portion 422.

The piezoresistive elements detect stresses in the beams 43A and 43B, and the acceleration of the acceleration sensor 40 is measured from detection results of the piezoresistive elements.

The first resonance mode of the acceleration sensor 40 is an oscillation mode of pendulum oscillation. In the acceleration sensor 40 according to Preferred Embodiment 4, the weight 41 and the supporting portions 421 and 422 have protrusion and recess shapes. When the weight 41 is displaced, maximum stresses occur at a connecting portion between the beam 43A and the protruded portion 42A of the supporting portion 421 as well as at a connecting portion between the beam 43B and the protruded portion 42B of the supporting portion 422. Accordingly, the acceleration may be detected at high accuracy by providing the piezoresistive elements in these connecting portions.

In the previous section, the acceleration sensors according to various preferred embodiments of the present invention are described in detail. However, the specific structure of the acceleration sensors and the like may be arbitrarily modified in designing, and are not limited to the ones described in the foregoing Preferred Embodiments.

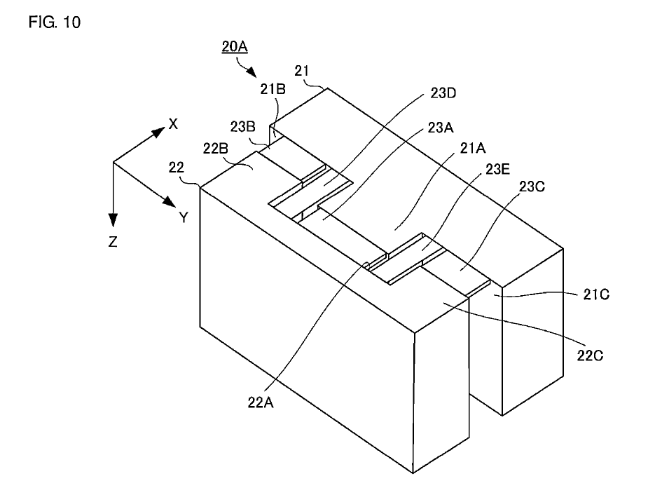

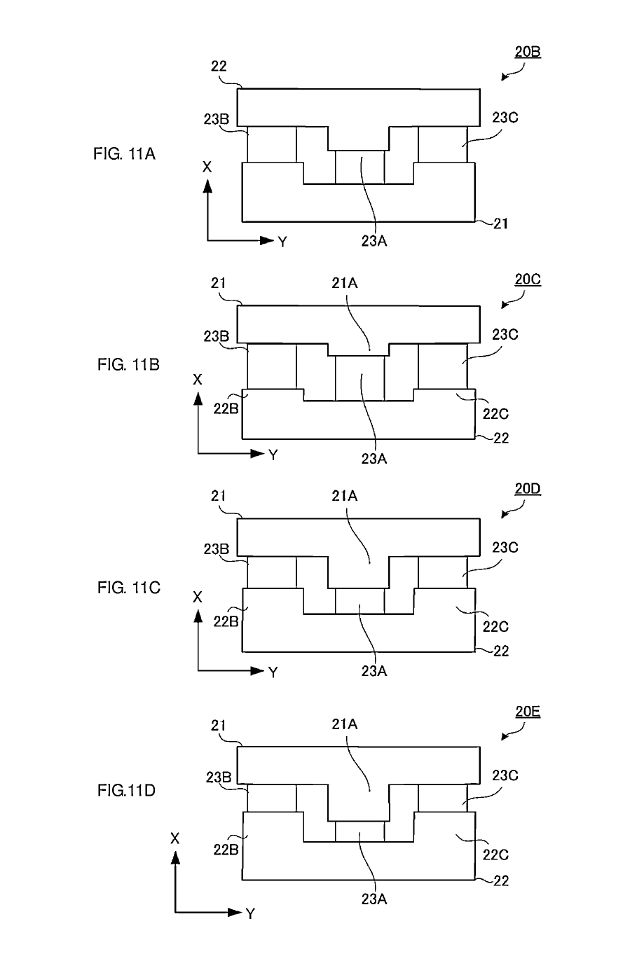

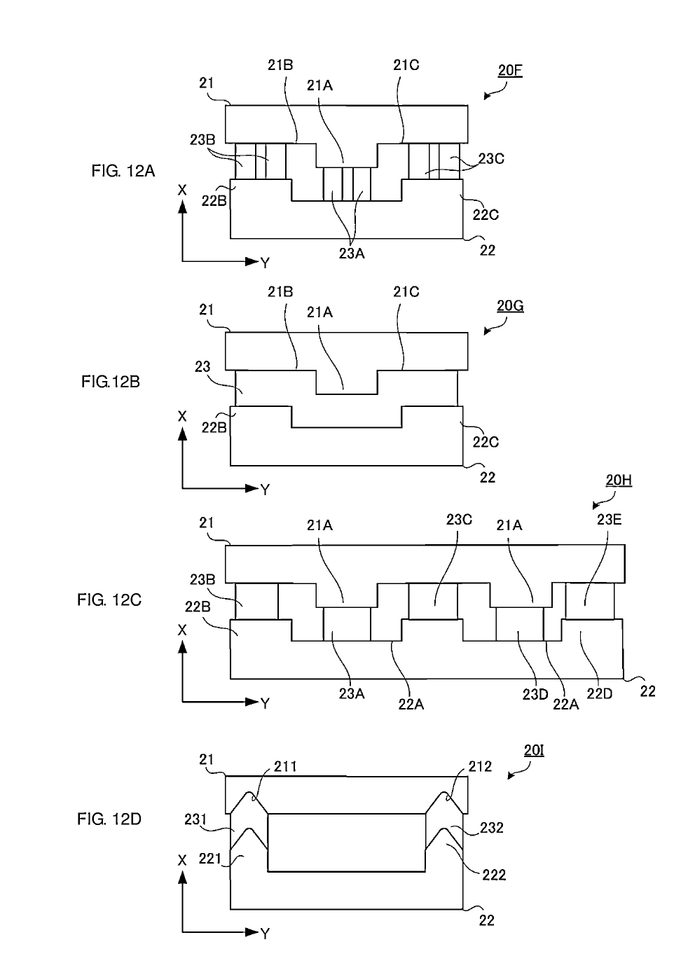

FIG. 10 is a diagrammatic perspective view of an acceleration sensor 20A that serves as a first modification example of the acceleration sensor according to Preferred Embodiment 2 of the present invention. FIGS. 11A-11D are schematic plan views of acceleration sensors 20B to 20E that serve as second to fifth modification examples of the acceleration sensor according to Preferred Embodiment 2 of the present invention. FIGS. 12A-12D are schematic plan views of acceleration sensors 20F to 20I that serve as sixth to ninth modification examples of the acceleration sensor according to Preferred Embodiment 2 of the present invention. FIGS. 11A-11D and FIGS. 12A-12D illustrate top plan views of the acceleration sensors.

For example, in Preferred Embodiment 2, spaces are provided between the protruded portion 21A and the surrounding regions 22B and 22C. However, in the acceleration sensor 20A illustrated in FIG. 10, additional beams are placed over the spaces between the protruded portion 21A and the surrounding regions 22B and 22C to close loopholes for air relating to the motion of the weight 21. In the acceleration sensor 20A, beams 23D and 23E are additionally disposed between the protruded portion 21A and the surrounding regions 22B and 22C. Provision of these beams 23D and 23E makes it possible to reduce a Q value by utilizing viscous resistance of air molecules between the weight 21 and the supporting portion 22, namely, damping effect. As a result, no filter circuit such as a notch filter or the like is required in a subsequent stage circuit to be connected to the acceleration sensor 10. Further, even in Preferred Embodiment 3, as in this modification example, additional beams may be disposed over spaces between the beams 33A, 33B, and 33C.

Further, in Preferred Embodiment 2, the weight 21 preferably has the protrusion shape and the supporting portion 22 has the recess shape in the X-Y axis plane. However, as in the acceleration sensor 20B illustrated in FIG. 11A, the weight 21 may have a recess shape and the supporting portion 22 may have a protrusion shape in the X-Y axis plane. Further, as in the acceleration sensor 20C illustrated in FIG. 11B, the protruded portion or surrounding portions may be configured to have shorter protrusions. Still further, as in the acceleration sensor 20D illustrated in FIG. 11C, the protruded portion 21A of the weight 21 and the surrounding portions 22B and 22C of the supporting portion 22 may be configured so that their end portions are located on a same line that is parallel or substantially parallel to the Y axis direction. The acceleration sensors 20B, 20C, and 20D illustrated in FIGS. 11A to 11C make it possible to concentrate stress in presence of acceleration, making it possible to achieve highly sensitive acceleration sensors. Further, as in the acceleration sensor 20E illustrated in FIG. 11D, the protruded portion 21A of the weight 21 and the surrounding portions 22B and 22C of the supporting portion 22 may be configured so that the protruded portion 21A enters in between the surrounding portions 22B and 22C. Note that, as in these modification examples, Preferred Embodiment 3 may alternatively be configured so as to have reversed recess and protrusion or modified protrusion lengths at the protruded portion 21A and the surrounding portions 23B and 23C.

Further, as in the acceleration sensor 20F illustrated in FIG. 12A, the beams 23A, 23B, and 23C may alternatively be configured so that each beam includes a pair of beams or composed of three or more beams. Still further, as in the acceleration sensor 20G illustrated in FIG. 12B, a single beam 23 may connect the weight 21 and the supporting portion 22. Further, as in the acceleration sensor 20H illustrated in FIG. 12C, the weight 21 may be provided with a plurality of the protruded portions 21A, and the supporting portion 22 may be provided with a plurality of the recessed portions 22A. In this case, additional beams 23D and 23E are disposed to connect the weight 21 and the supporting portion 22. The acceleration sensors 20F to 20H illustrated in FIGS. 12A to 12C make it possible to concentrate stress, thus making it possible to achieve highly sensitive acceleration sensors. Note that, as in these modification examples, Preferred Embodiment 3 may alternatively be configured so as to have modified beam shapes.

Further, as in the acceleration sensor 20I illustrated in FIG. 12D, the weight 21 may alternatively be configured to have, in the X-Y axis plane, an approximately rectangular shape in which V-shaped recessed portions 211 and 212 are provided at both end portions of the weight 21 in the Y axis direction. Further, protruded portions 221 and 222 may be provided at portions that face the recessed portions 211 and 212 of the weight 21. In this case, beams 231 and 232 are disposed between the recessed portions 211 and 212 and the protruded portions 221 and 222. The structure with the V-shaped recesses and protrusions makes it possible to provide similar effects while reducing the number of beams compared with the structures illustrated in FIGS. 12A to 12C.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2: An acceleration sensor comprising:
a weight;
a supporting portion arranged so as to face the weight;
a beam configured to be flexible and connect the weight and the supporting portion; and
a piezoresistive element disposed at the beam; wherein
the weight is configured to move in a pendulum motion in presence of acceleration.

3: The acceleration sensor according to claim 2, wherein
one of the weight and the supporting portion includes a protruded portion that protrudes toward another one of the weight and the supporting portion;
the another one of the weight and the supporting portion includes a recessed portion that faces the protruded portion; and
the beam includes a first beam disposed between the protruded portion and the recessed portion and a second beam disposed at a location that does not exist between the protruded portion and the recessed portion.

4: The acceleration sensor according to claim 3, further comprising:
a first piezoresistive bridge disposed at the first beam; and
a second piezoresistive bridge disposed at the second beam.

5: The acceleration sensor according to claim 3, wherein the protruded portion is located inside the recessed portion.

6: The acceleration sensor according to claim 3, wherein the protruded portion is located outside the recessed portion.

7: The acceleration sensor according to claim 2, wherein the acceleration sensor is a micro-electromechanical systems piezoresistive acceleration sensor.

8: The acceleration sensor according to claim 2, wherein the weight is supported by the beams to define a cantilever configuration.

9: The acceleration sensor according to claim 2, wherein the beam is provided in plural.

10: The acceleration sensor according to claim 2, wherein the supporting portion has a recess shape including a rectangular or substantially rectangular portion with a longer side that has a same or substantially a same length as that of the weight.

11: The acceleration sensor according to claim 10, wherein the recess shape includes two protruded portions at both end portions of the longer side of the rectangular or substantially rectangular portion.

12: The acceleration sensor according to claim 2, wherein the weight and the supporting portion have planar shapes with protrusion and recess shapes.

13: The acceleration sensor according to claim 2, wherein the piezoresistive element is provided in plural, and the plural piezoresistive elements are connected so as to define a Wheatstone bridge and to define a piezoresistive bridge.

14: The acceleration sensor according to claim 2, wherein the beam is provided in plural, and the plural beams are configured such that a direction of acceleration detected at a first of the beams is not aligned with a direction of acceleration detected at others of the beams.

15: The acceleration sensor according to claim 2, wherein the weight includes a protruded portion and the supporting portion includes surrounding regions, spaces are provided between the protruded portion and the surrounding regions, and additional beams are disposed over the spaces between the protruded portion and the surrounding regions.

16: The acceleration sensor according to claim 2, wherein
the weight has one of a protrusion shape and a recess shape, and the supporting portion has one of recess shape and a protrusion shape.

17: The acceleration sensor according to claim 2, wherein the weight includes a plurality of protruded portions and the supporting portion includes a plurality of the recessed portions.
